(19) United States
(12) Patent Application Publication
(10) Pub. No.: US 2017/0208356 A1
(43) Pub. Date: Jul. 20, 2017

(54) VIDEO PLAYING METHOD AND SYSTEM

(71) Applicant: Conew Network Technology (Beijing) Co., Ltd., Beijing (CN)

(72) Inventors: Shimeng XU, Beijing (CN); Dingpan LI, Beijing (CN); Hong LI, Beijing (CN)

(21) Appl. No.: 15/324,623

(22) PCT Filed: Jul. 15, 2015
(86) PCT No.: PCT/CN2015/084051

§ 371 Date: Jan. 6, 2017

(30) Foreign Application Priority Data
Jul. 15, 2014 (CN) 201410334744.7

(51) Int. Cl. H04N 21/431; H04N 21/443; H04N 21/472; H04N 21/4402; H04N 21/414

(52) U.S. Cl. CPC H04N 21/4312; H04N 21/4402; H04N 21/41407; H04N 21/472; H04N 21/4438

(57) ABSTRACT

Embodiments of the present application provide a video playing method and system, which enables playing a first video frame in a video playing window located in part of the display area according to a video playing instruction, then setting the playing time of subsequent video frames, and playing corresponding video frames in the video playing window at the playing time. Therefore, in the present application, it is possible to playing a video in part of the display area of a mobile terminal. Furthermore, since a mobile terminal can have a plurality of different display areas, when the solution of the present application is applied to at least two display areas, multiple videos are displayed in the mobile terminal simultaneously. Therefore, the present application achieves the effect of displaying multiple videos on the screen of a mobile terminal.

The present application claims priority to Chinese patent application No. 201410334744.7, entitled “VIDEO PLAYING METHOD AND SYSTEM” and filed before China Patent Office on Jul. 15, 2014, the entire content of which is incorporated in the present application by reference.

### TECHNICAL FIELD

The present application relates to the technical field of multimedia playing, especially to a video playing method and system.

### BACKGROUND

With the development of technology, there are a growing number of functions for mobile terminals such as cell phones, and a user often watches a video by means of a mobile terminal.

Due to the fact that the screen of a mobile terminal is relatively small, a video is played on an existing mobile terminal in full-screen mode and a user can only watch one video currently being played on a screen. As the size of the screen of a mobile terminal is increasing, there is a need that a user wishes to watch at least two videos being played on one screen. Therefore, it becomes an urgent issue as to how to playing at least two videos on the screen of a mobile terminal.

Obviously, the playing of other videos in a mobile terminal has the same problem.

### SUMMARY OF THE INVENTION

The objective of embodiments of the present application is to provide a video playing method and system for the purpose of playing at least two videos simultaneously in a mobile terminal.

In order to achieve the above objective, embodiments of the present application disclose a video playing method, which is applied to a mobile terminal, the method comprises:

obtaining a video playing instruction for playing a video in a video playing window located in a first display area of the mobile terminal, the first display area being part of the display area of the mobile terminal;

playing a first video frame of a video corresponding to the video playing instruction in the video playing window located in the first display area according to the video playing instruction;

determining video frames to be played according to a preset frame rate, wherein, the video frames to be played are all or part of video frames except for the first video frame in the video corresponding to the video playing instruction; arranging each video frame of the video frames to be played and the first video frame according to a sequential playing order so as to generate a video frame playing sequence;

sequentially selecting, according to the sequential playing order, each video frame in the video frame playing sequence as a current video frame, so as to perform the following processing:

determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

Optionally, the method further includes:

receiving an adjusting instruction for the video playing window located in the first display area from a user, the adjusting instruction being a zoom-in instruction a zoom-out instruction or a moving instruction;

adjusting the video playing window according to the adjusting instruction.

Optionally, the video playing window is a widget window.

Optionally, before obtaining a video playing instruction for playing a video in a video playing window located in a first display area of the mobile terminal, the method further comprises:

displaying an identifier of at least one video file in the widget window located in the first display area of the mobile terminal;

the step of obtaining a video playing instruction for playing a video in a video playing window located in a first display area of the mobile terminal comprises:

receiving a selection instruction for an identifier of a video file displayed in the widget window from a user and taking the selection instruction as the video playing instruction for playing the video in the widget window located in the first display area of the mobile terminal.

Optionally, before displaying an identifier of at least one video file in the widget window located in the first display area of the mobile terminal, the method further comprises:

receiving a widget establishing instruction from a user;

establishing a widget window in the first display area of the mobile terminal.

Embodiments of the present application also disclose a video playing system, which is applied to a mobile terminal, the system comprises: a playing instruction obtaining unit, a first video frame playing unit, a video frame obtaining unit and a subsequent video frame playing unit,

the playing instruction obtaining unit is used for obtaining a video playing instruction for playing a video in a video playing window located in a first display area of the mobile terminal, the first display area being part of the display area of the mobile terminal;

the first video frame playing unit is used for playing the first video frame of the video corresponding to the video playing instruction in the video playing window located in the first display area according to the video playing instruction;

the video frame obtaining unit is used for determining video frames to be played according to a preset frame rate, wherein, the video frames to be played are all or part of video frames except for the first video frame, in the video corresponding to the video playing instruction, arranging each video frame of the video frames to be played and the first video frame according to a sequential playing order, so as to generate a video frame playing sequence;

the subsequent video frame playing unit is used for sequentially selecting, according to the sequential playing order, each video frame in the video frame playing sequence as a current video frame, so as to perform the following processing:

determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

Optionally, the system further comprises: an adjusting instruction receiving unit and a window adjusting unit,

the adjusting instruction receiving unit is used for receiving an adjusting instruction for the video playing window located in the first display area from a user, the adjusting instruction being a zoom-in instruction a zoom-out instruction or a moving instruction;

the window adjusting unit is used for adjusting the video playing window according to the adjusting instruction.

Optionally, the video playing window is a widget window.

Optionally, the system further comprises: a video identifier display unit, which is used for displaying an identifier of at least one video file in the widget window located in the first display area of the mobile terminal, before the playing instruction obtaining unit obtains the video playing instruction for playing a video in the video playing window located in the first display area of the mobile terminal;

wherein, the playing instruction obtaining unit is specifically used for receiving a selection instruction for an identifier of a video file displayed in the widget window from a user and taking the selection instruction as the video playing instruction for playing the video in the widget window located in the first display area of the mobile terminal.

Optionally, the system further comprises: an establishing instruction receiving unit and a widget window establishing unit,

the establishing instruction receiving unit is used for receiving a widget establishing instruction from a user before the video identifier displaying unit displays the identifier of at least one video file in the widget window located in the first display area of the mobile terminal;

the widget window establishing unit is used for establishing a widget window in the first display area of the mobile terminal.

Accordingly, embodiments of the present application further provide a storage medium, wherein, the storage medium is used for storing an application program, which application program is used to perform the video playing method of the present application while running. Wherein, the video playing method of the present application is applied to a mobile terminal, the method comprises:

obtaining a video playing instruction for playing a video in a video playing window located in a first display area of the mobile terminal, the first display area being part of the display area of the mobile terminal;

playing a first video frame of a video corresponding to the video playing instruction in the video playing window located in the first display area according to the video playing instruction;

determining video frames to be played according to a preset frame rate, wherein, the video frames to be played are all or part of video frames except for the first video frame in the video corresponding to the video playing instruction; arranging each video frame of the video frames to be played and the first video frame according to a sequential playing order so as to generate a video frame playing sequence;

sequentially selecting, according to the sequential playing order, each video frame in the video frame playing sequence as a current video frame, so as to perform the following processing:

determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

Accordingly, embodiments of the present application further provide an application program, which is used to perform the video playing method of the present application while running. Wherein, the video playing method of the present application is applied to a mobile terminal, the method comprises:

obtaining a video playing instruction for playing a video in a video playing window located in a first display area of the mobile terminal, the first display area being part of the display area of the mobile terminal;

playing a first video frame of a video corresponding to the video playing instruction in the video playing window located in the first display area according to the video playing instruction;

determining video frames to be played according to a preset frame rate, wherein, the video frames to be played are all or part of video frames except for the first video frame in the video corresponding to the video playing instruction; arranging each video frame of the video frames to be played and the first video frame according to a sequential playing order so as to generate a video frame playing sequence;

sequentially selecting, according to the sequential playing order, each video frame in the video frame playing sequence as a current video frame, so as to perform the following processing:

determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

Accordingly, embodiments of the present application further provide a mobile terminal, which comprises:

a processor, a memory, communication interfaces and a communication bus;

the processor, the memory, and the communication interfaces being connected and communicated with each other via the communication bus;

the memory storing executable program codes;

the processor executing the program corresponding to the executable program codes by reading the executable program codes stored in the memory, so as to perform the steps of:

obtaining a video playing instruction for playing a video in a video playing window located in a first display area of the mobile terminal, the first display area being part of the display area of the mobile terminal;

playing a first video frame of a video corresponding to the video playing instruction in the video playing window located in the first display area according to the video playing instruction;

determining video frames to be played according to a preset frame rate, wherein, the video frames to be played are all or part of video frames except for the first video frame in the video corresponding to the video playing instruction; arranging each video frame of the video frames to be played and the first video frame according to a sequential playing order so as to generate a video frame playing sequence;

sequentially selecting, according to the sequential playing order, each video frame in the video frame playing sequence as a current video frame, so as to perform the following processing:

determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

In the video playing method and system provided by embodiments of the present application, first, a first video frame may be played in a video playing window located in part of the display area according to a video playing instruction, and then the playing time of subsequent video frames may be set and the corresponding video frames may be played in a video playing window at the playing time. Therefore, the present application enables playing a video in part of the display area of a mobile terminal. Furthermore, since a mobile terminal can have a plurality of different display areas, when the solution of the present application is applied to at least two different display areas, multiple videos are displayed in the mobile terminal simultaneously. Therefore, the present application achieves the effect of displaying multiple videos on the screen of a mobile terminal.

### BRIEF DESCRIPTION OF DRAWINGS

In order to describe the embodiments of the present application and the technical solutions in prior art more clearly, drawings used for embodiments of the present application and prior art will be described briefly below. It is obvious that the drawings below are only for some embodiments of the present application, and those skilled in the art can also obtain further drawings based on these drawings without any creative efforts.

FIG. 1 is a flowchart of a video playing method provided by embodiments of the present application;

FIG. 2 is a flowchart of another video playing method provided by embodiments of the present application;

FIG. 3 is a flowchart of another video playing method provided by embodiments of the present application;

FIG. 4 is a schematic structural illustration of a video playing method provided by embodiments of the present application;

FIG. 5 is a schematic structural illustration of another video playing method provided by embodiments of the present application;

FIG. 6 is a schematic structural illustration of another video playing method provided by embodiments of the present application.

### DETAILED DESCRIPTION OF THE INVENTION

The technical solutions of the present application will be described in detail below with reference to the appended drawings. Obviously, the described embodiments are only some of the embodiments of the present application, rather than all of the embodiments. All other embodiments obtained based on the embodiments of the present application by those skilled in the art without doing creative works fall into the protection scope of the present application.

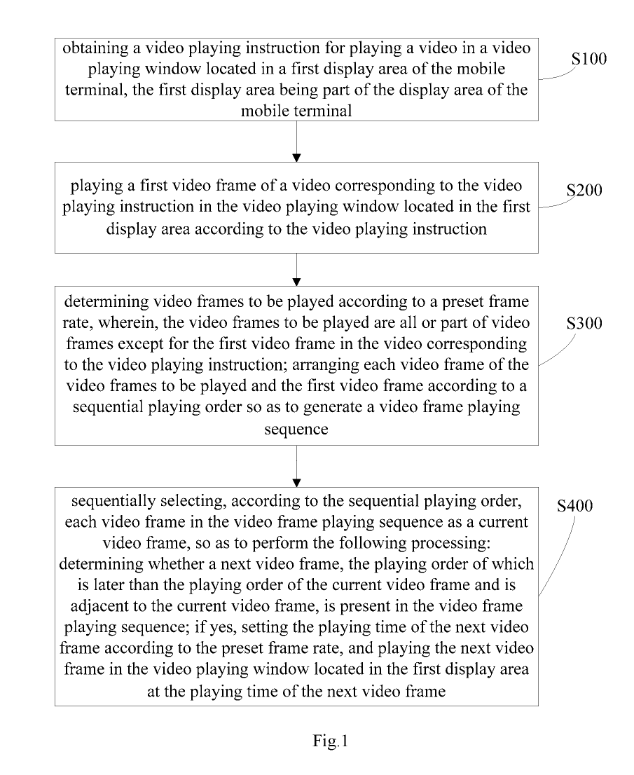

As shown in FIG. 1, embodiments of the present application provide a video playing method, which is applied to a mobile terminal, the method may comprise:

S100. obtaining a video playing instruction for playing a video in a video playing window located in a first display area of the mobile terminal, the first display area being part of the display area of the mobile terminal.

Optionally, a user can select the display area and the video to be played by two selection operations. For example: a user selects a video to be played in the memory card of a mobile terminal, and then selects the first display area in the screen of a mobile terminal for playing this video. A user can also select the display area and the video to be played by one selection operation. For example, a user drags the video to be played into the first display area. Therefore, optionally, the video playing instruction can contain two selection operations or it can contain one selection operation.

S200. playing a first video frame of a video corresponding to the video playing instruction in the video playing window located in the first display area according to the video playing instruction.

It can be understood that, a mobile terminal will generate a corresponding system message after receiving various instructions from a user, and the mobile terminal is controlled to fulfill various actions by the system message. For example, if a user clicks on the clock icon displayed on a mobile terminal, the mobile terminal will generate a system message, display the clock on the screen, and then constantly generate system messages for updating time as time goes by, so as to change the time displayed by the clock. Of course, the system messages for updating time is not generated according to the user's instruction, but they are generated with the signal of a timing apparatus (for example a crystal oscillator) in the mobile terminal.

When obtaining the video playing instruction sent by a user, the mobile terminal generates, correspondingly, a system message of playing, in the display area, the video frame whose playing order is the first in a video, but the mobile terminal will not generate system messages of playing subsequent video frames. Therefore, S200 may comprise: playing the first video frame of a video corresponding to the video playing instruction in the video playing window located in the first display area according to a system message trigged by the video playing instruction.

S300. determining video frames to be played according to a preset frame rate, wherein, the video frames to be played are all or part of video frames except for the first video frame in the video corresponding to the video playing instruction; arranging each video frame of the video frames to be played and the first video frame according to a sequential playing order so as to generate a video frame playing sequence;

Frame rate is the number of video frames displayed per second, whose unit is FPS. Specifically, the playing time interval between neighboring video frames in a video may be determined according to the frame rate of the video. For example, for a video whose frame rate is 25 FPS, the number of frames displayed per second is 25, therefore the playing time interval between neighboring video frames is 0.04 s. Wherein, there could be several frame rates of a video, for example, 24 FPS, 25 FPS, 30 FPS.

Wherein, the preset frame rate can be not only the initial frame rate of the video, but also a non-initial frame rate set by a user. For example, the initial frame rate is 30 FPS and the user can set a preset frame rate as 24 FPS. As such, when playing a video, only a part of video frames in the video need to be selected to play. When the preset frame rate is the initial frame rate, the video frames to be played are all of the video frames except for the first one. It can be understood that, it would be an operation burden for the system of a mobile terminal to play a video with relatively high frame rate due to its inferior hardware performance. Meanwhile, playing a video with relatively high frame rate cannot bring better viewing experience to the user, since the size of the screen of a mobile terminal is relatively small. Therefore, the frame rate of a video can be reduced without affecting user's viewing experience in order to reduce the operation burden of the system. The present application can select all or part of video frames except for the first one in a video as the video frames to be played, thereby reducing the frame rate of the video effectively.

Specifically, the method of determining video frames to be played according to a preset frame rate may comprise:

Step 1, determining the display time interval of each of the video frames except for the first video frame in a video corresponding to the video playing instruction;

Step 2, determining multiple display time intervals that match with a preset frame rate according to the preset frame rate;

Step 3, for the matched display time intervals except for the matched first display time interval, taking the video frames except for the first one which are displayed within the matched display time interval as the video frames to be selected in the matched display time interval;

Step 4, selecting one of the video frames to be selected respectively as the video frame displayed in the corresponding matched display time interval, and taking the selected video frame as the video frame to be played.

For better understanding, examples are given below for illustration:

Assuming the duration of a video is 1 second, the initial frame rate of the video is 5 FPS, and the preset frame rate set by a user is 4 FPS, then for the initial frame rate, five video frames are displayed per second, whereas for a preset frame rate, four video frames are displayed per second. The start time for playing a video is set to be 0 s. The display time intervals of each video frame except for the first one determined in step 1 are: 0.2 s to 0.4 s for the second video frame, 0.4 s to 0.6 s for the third video frame, 0.6 s to 0.8 s for the fourth video frame, 0.8 s to 1.0 s for the fifth video frame.

Multiple display time intervals that match with the preset frame rate, except for the first matched display time interval, determined in step 2 are: the second interval: 0.25 s to 0.5 s; the third interval: 0.5 s to 0.75 s; the fourth interval: 0.75 s to 1.0 s.

In Step 3, the second video frame and the third video frame displayed in the second interval are taken as the video frames to be selected for the second interval, and the third and fourth video frames displayed in the third interval are taken as the video frames to be selected for the third interval, and the fourth and fifth video frames displayed in the fourth interval as the video frames to be selected for the fourth interval.

In Step 4, the second, fourth and fifth video frames are taken as the video frames to be played. As such, the first video, second, fourth and fifth video frames are arranged according the sequential playing order so as to generate a video frame playing sequence.

Specifically, there are many selection methods for step 4. For example, taking the video frame that is firstly played in the video frames to be selected within each matched display time interval as the video frame to be played, or taking the video frame whose playing duration is relatively long within the matched display time intervals as the video frame to be played, and the like.

S400. sequentially selecting, according to the sequential playing order, each video frame in the video frame playing sequence as a current video frame, so as to perform the following processing: determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

In the video playing method and system provided by embodiments of the present application, first, a first video frame may be played in a video playing window located in part of the display area according to a video playing instruction, and then the playing time of subsequent video frames may be set and the corresponding video frames may be played in a video playing window at the playing time. Therefore, the present application enables playing a video in part of the display area of a mobile terminal. Furthermore, since a mobile terminal can have a plurality of different display areas, when the solution of the present application is applied to at least two different display areas, multiple videos are displayed in the mobile terminal simultaneously. Therefore, the present application achieves the effect of displaying multiple videos on the screen of a mobile terminal.

Optionally, in other embodiments of the present application, a user can also adjust the size, location of a video playing window. Therefore, optionally, the embodiment shown in FIG. 1 may further comprise:

receiving an adjusting instruction for the video playing window located in the first display area from a user, the adjusting instruction being a zoom-in instruction a zoom-out instruction or a moving instruction;

adjusting the video playing window according to the adjusting instruction.

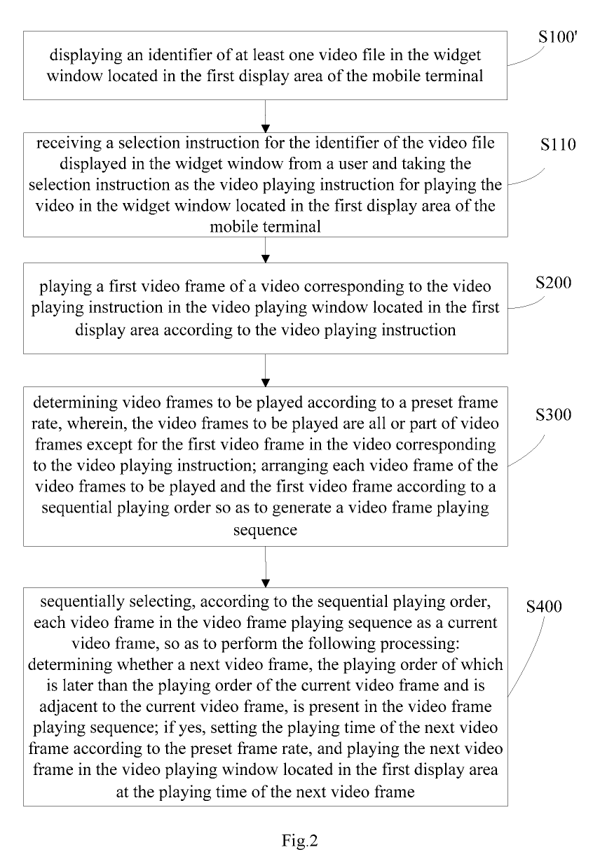

Optionally, the video playing window in the embodiment of the present application may be a widget window. As shown in FIG. 2, on the basis of the embodiment of FIG. 1, before the step S100 in the embodiment shown in FIG. 1, the method may further comprise:

S100′, displaying an identifier of at least one video file in the widget window located in the first display area of the mobile terminal;

As shown in FIG. 2, S100 of the embodiment shown in FIG. 1 may comprise:

S110, receiving a selection instruction for an identifier of a video file displayed in the widget window from a user and taking the selection instruction as the video playing instruction for playing the video in the widget window located in the first display area of the mobile terminal.

Widget has various types, and the most common one is a small gadget on desktop, such as clock, diary and weather forecast etc. A user can add these widgets directly to his/her computer desktop for use, thus improving the functionality of the desktop. Since a widget can take up a part of the display area and the operations of different widgets don not interfere with each other, therefore a plurality of same or different widgets can be added to a same desktop.

The existing widgets are updated by events (i.e., a system message). For example, the variation of electricity, WIFI etc. can be monitored, and the widget will be updated when these events occur, so as to realize corresponding functions. However, for video playing, since a video playing instruction only enables a mobile terminal to generate a system message for playing the first video frame of a video, the existing widget cannot play subsequent video frames of a video. The present application can perfect the updating mechanism of a widget by setting playing time, and after the first video frame in the video is played according to the system message, the present application can determine the video frames to be played according to the preset frame rate so as to generate a video frame playing sequence. The playing time is set sequentially for a next video frame in the video frame playing sequence and the corresponding video frame is played at the playing time. Therefore, the present application enables a widget to successively play a video, and meanwhile to play multiple videos on one screen of a mobile terminal by widgets since playing various videos by means of multiple widgets does not interfere with each other.

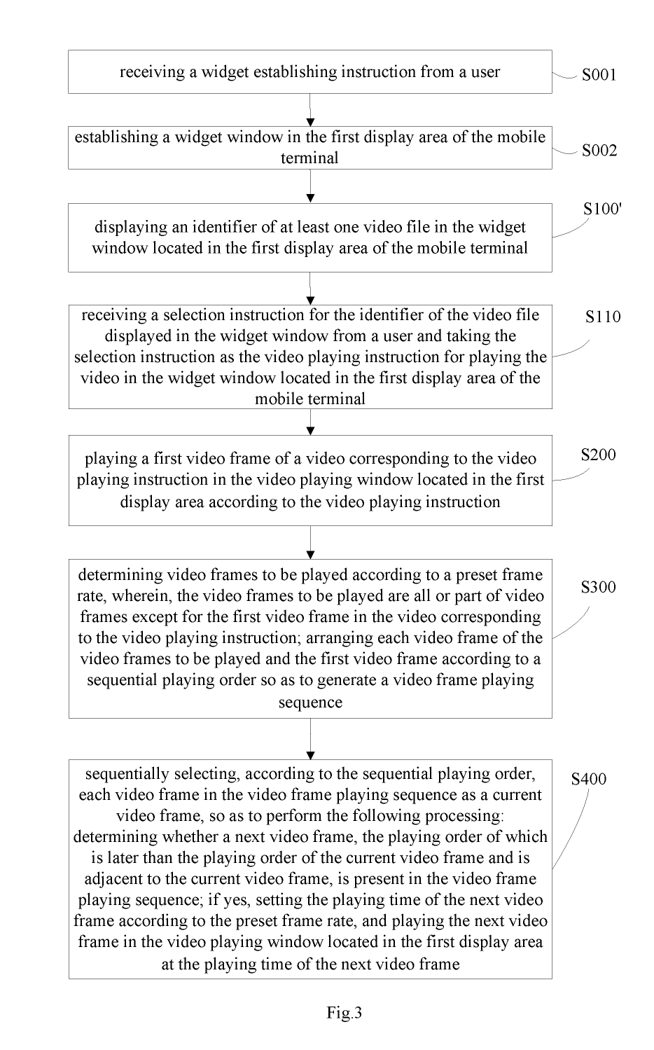

Of course, on the basis of the embodiment shown in FIG. 2, as shown in FIG. 3, another video playing method provided by embodiments of the present application may further comprise the following steps before S100′:

S001, receiving a widget establishing instruction from a user;

S002, establishing a widget window in the first display area of the mobile terminal.

Description will be given below by taking a video as an example:

First, a user establishes two video playing widgets in a mobile terminal. Specifically, a user may establish the widgets by dragging widget icons or by other ways. There may be a video display/playing window, a video playing control button etc. in a video playing widget. Of course, a user can also move, zoom in, zoom out the video playing widgets by dragging.

Second, a user selects two video files to be played in the above two video playing widgets respectively, and clicks on the video playing buttons in the above two video playing widgets respectively. The mobile terminal generates two system messages, which enable to the above two video playing widgets play the first video frame of the video files to be played in the playing window of the corresponding video playing widgets respectively.

Finally, the mobile terminal determines whether a subsequent video frame following the first video frame is present in the above two video files; if yes, then generating a video frame playing sequence according to the preset frame rate and sets the playing time for the next video frame, and then a corresponding video frame will be played at the playing time, which enables playing two videos on the display screen of a mobile terminal.

Correspondingly to above embodiments of a method, the present application further provides a video playing system.

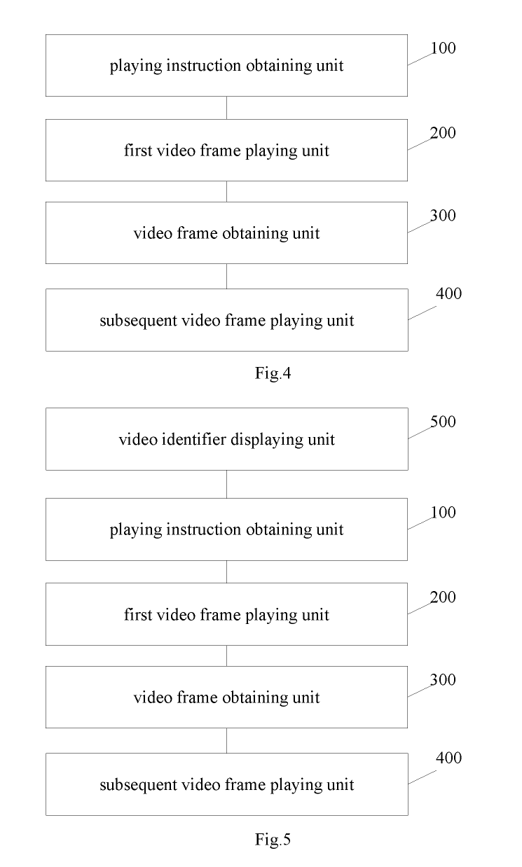

As shown in FIG. 4, the video playing system provided by embodiments of the present application is applied to a mobile terminal, which may comprise: a playing instruction obtaining unit 100, a first video frame playing unit 200, a video frame obtaining unit 300 and a subsequent video frame playing unit 400,

the playing instruction obtaining unit 100 is used for obtaining a video playing instruction for playing a video in a video playing window located in a first display area of the mobile terminal, the first display area being part of the display area of the mobile terminal;

the first video frame playing unit 200 is used for playing the first video frame of a video corresponding to the video playing instruction in the video playing window located in the first display area according to the video playing instruction;

the first video frame playing unit 200 may be specifically used for playing, in the video playing window in the first display area, the first video frame of a video corresponding to the video playing instruction, according to a system message triggered by the video playing instruction;

the video frame obtaining unit 300 is used for determining video frames to be played according to a preset frame rate, wherein, the video frames to be played are all or part of video frames except for the first video frame, in the video corresponding to the video playing instruction; arranging each video frame of the video frames to be played and the first video frame according to a sequential playing order so as to generate a video frame playing sequence;

the subsequent video frame playing unit 400 is used for sequentially selecting, according to the sequential playing order, each video frame in the video frame playing sequence as a current video frame, so as to perform the following processing: determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

In the video playing method and system provided by embodiments of the present application, first, a first video frame may be played in a video playing window located in part of the display area according to a video playing instruction, and then the playing time of subsequent video frames may be set and the corresponding video frames may be played in a video playing window at the playing time. Therefore, the present application enables playing a video in part of the display area of a mobile terminal. Furthermore, since a mobile terminal can have a plurality of different display areas, when the solution of the present application is applied to at least two different display areas, multiple videos are displayed in the mobile terminal simultaneously. Therefore, the present application achieves the effect of displaying multiple videos on the screen of a mobile terminal.

Another video playing system provided by embodiments of the present application may further comprise: an adjusting instruction receiving unit and a window adjusting unit,

the adjusting instruction receiving unit is used for receiving an adjusting instruction for the video playing window located in the first display area from a user, the adjusting instruction being a zoom-in instruction a zoom-out instruction or a moving instruction;

the window adjusting unit is used for adjusting the video playing window according to the adjusting instruction.

Optionally, the video playing window in the embodiment of the present application may be a widget window. On the basis of the system shown in FIG. 4, as shown in FIG. 5, the system may further comprise: a video identifier display unit 500, which is used for displaying an identifier of at least one video file in a widget window located in the first display area of the mobile terminal before the playing instruction obtaining unit 100 obtains the video playing instruction for playing a video in the video playing window located in the first display area of the mobile terminal;

wherein, the playing instruction obtaining unit 100 is specifically used for receiving a selection instruction for an identifier of a video file displayed in the widget window from a user and taking the selection instruction as the video playing instruction for playing the video in the widget window located in the first display area of the mobile terminal.

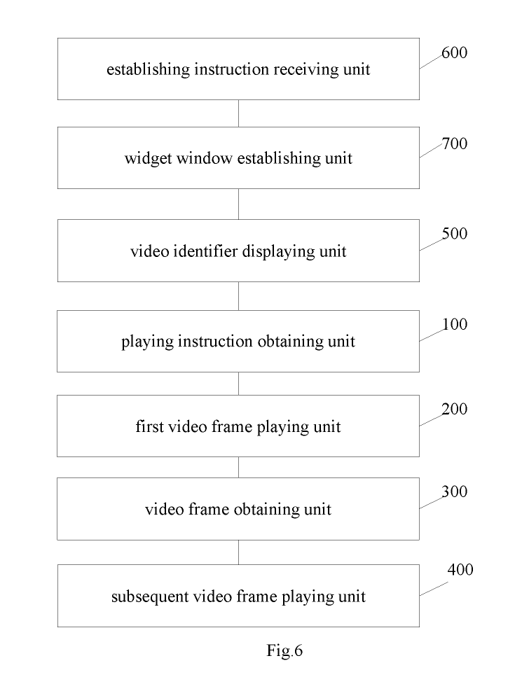

Of course, based on the embodiment shown in FIG. 5, as shown in FIG. 6, in another video playing system provided by embodiments of the present application, it may further comprise: an establishing instruction receiving unit 600 and a widget window establishing unit 700,

the establishing instruction receiving unit 600 is used for receiving a widget establishing instruction from a user before the video identifier displaying unit 500 displays the identifier of at least one video file in a widget window located in the first display area of the mobile terminal,

the widget window establishing unit 700 is used for establishing a widget window in the first display area of the mobile terminal.

Accordingly, embodiments of the present application further provide a storage medium, wherein, the storage medium is used to store an application program, which is used to perform the video playing method of the present application while running. Wherein, the video playing method of the present application is applied to a mobile terminal, the method comprises:

obtaining a video playing instruction for playing a video in a video playing window located in a first display area of the mobile terminal, the first display area being part of the display area of the mobile terminal;

playing a first video frame of a video corresponding to the video playing instruction in the video playing window located in the first display area according to the video playing instruction;

determining video frames to be played according to a preset frame rate, wherein, the video frames to be played are all or part of video frames except for the first video frame in the video corresponding to the video playing instruction; arranging each video frames of the video frame to be played and the first video frame according to a sequential playing order so as to generate a video frame playing sequence;

sequentially selecting, according to the sequential playing order, each video frame in the video frame playing sequence as a current video frame, so as to perform the following processing:

determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

Accordingly, embodiments of the present application further provide an application program, which is used to perform the video playing method of the present application while running. Wherein, the video playing method of the present application is applied to a mobile terminal, the method comprises:

obtaining a video playing instruction for playing a video in a video playing window located in a first display area of the mobile terminal, the first display area being part of the display area of the mobile terminal;

playing a first video frame of a video corresponding to the video playing instruction in the video playing window located in the first display area according to the video playing instruction;

determining video frames to be played according to a preset frame rate, wherein, the video frames to be played are all or part of video frames except for the first video frame in the video corresponding to the video playing instruction; arranging each video frame of the video frame to be played and the first video frame according to a sequential playing order so as to generate a video frame playing sequence;

sequentially selecting, according to the sequential playing order, each video frame in the video frame playing sequence as a current video frame, so as to perform the following processing:

determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

Accordingly, embodiments of the present application further provide a mobile terminal, which comprises:

a processor, a memory, communication interfaces and a communication bus;

the processor, the memory, and the communication interfaces being connected and communicated with each other via the communication bus;

the memory storing executable program codes;

the processor executing the program corresponding to the executable program codes by reading the executable program codes stored in the memory, so as to perform the steps of:

obtaining a video playing instruction for playing a video in a video playing window located in a first display area of the mobile terminal, the first display area being part of the display area of the mobile terminal;

playing a first video frame of a video corresponding to the video playing instruction in the video playing window located in the first display area according to the video playing instruction;

determining video frames to be played according to a preset frame rate, wherein, the video frames to be played are all or part of video frames except for the first video frame in the video corresponding to the video playing instruction; arranging each video frame of the video frames to be played and the first video frame according to a sequential playing order so as to generate a video frame playing sequence;

sequentially selecting, according to the sequential playing order, each video frame in the video frame playing sequence as a current video frame, so as to perform the following processing:

determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

It should be noted that the relationship terms herein such as “first”, “second” and the like are only used to distinguish one entity or operation from another entity or operation, but do not necessarily require or imply that there is actual relationship or order between these entities or operations. Moreover, the terms “include”, “comprise” or any variants thereof are intended to cover a non-exclusive inclusion, such that processes, methods, articles or devices comprising a series of elements comprise not only those elements listed, but also other elements not specifically listed or the elements intrinsic to these processes, methods, articles, or devices. Without further limitations, elements limited by the wording “comprise(s) a/an . . . ” do not exclude that there are additional identical elements in the processes, methods, articles, or devices which comprise the listed elements.

All embodiments in the description are described in a correlated manner, and identical or similar parts in various embodiments can be referred to one another, the description for each embodiment all focuses on the differences with other embodiments. Especially, the embodiments of a system are briefly described and reference can be made to the description of the embodiments of a method for its related contents since the embodiments of the device are substantially similar to those of the method.

The embodiments described above are just preferable embodiments of the present application, and not indented to limit the protection scope of the present application. Any modifications, alternatives, improvements or the like within the spirit and principle of the present application shall be comprised in the protection scope of the present application.

1. A video playing method, characterized in that it is applied to a mobile terminal, and the method comprises:
obtaining a video playing instruction for playing a video in a video playing window located in a first display area of the mobile terminal, the first display area being part of the display area of the mobile terminal;
playing a first video frame of a video corresponding to the video playing instruction in the video playing window located in the first display area according to the video playing instruction;
determining video frames to be played according to a preset frame rate, wherein, the video frames to be played are all or part of video frames except for the first video frame in the video corresponding to the video playing instruction; arranging each video frame of the video frames to be played and the first video frame according to a sequential playing order so as to generate a video frame playing sequence;
sequentially selecting, according to the sequential playing order, each video frame in the video frame playing sequence as a current video frame, so as to perform the following processing:
determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

2. The method according to claim 1, characterized in that, it further includes:
receiving an adjusting instruction for the video playing window located in the first display area from a user, the adjusting instruction being a zoom-in instruction, a zoom-out instruction or a moving instruction;
adjusting the video playing window according to the adjusting instruction.

3. The method according to claim 1, characterized in that, the video playing window is a widget window.

4. The method according to claim 3, characterized in that, before obtaining a video playing instruction for playing a video in a video playing window located in a first display area of the mobile terminal, the method further comprises:
displaying an identifier of at least one video file in the widget window located in the first display area of the mobile terminal;
the step of obtaining a video playing instruction for playing a video in a video playing window located in a first display area of the mobile terminal comprises:
receiving a selection instruction for an identifier of a video file displayed in the widget window from a user and taking the selection instruction as the video playing instruction for playing the video in the widget window located in the first display area of the mobile terminal.

5. The method according to claim 4, characterized in that, before displaying an identifier of at least one video file in the widget window located in the first display area of the mobile terminal, the method further comprises:
receiving a widget establishing instruction from a user;
establishing a widget window in the first display area of the mobile terminal.

6. A mobile terminal, characterized in that it comprises a processor, a memory, communication interfaces and a communication bus;
the processor, the memory, and the communication interfaces being connected and communicated with each other via the communication bus;
the memory storing executable program codes;
the processor executing the program corresponding to the executable program codes by reading the executable program codes stored in the memory, so as to perform the steps of:
obtaining a video playing instruction for playing a video in a video playing window located in a first display area of the mobile terminal, the first display area being part of the display area of the mobile terminal;
playing the first video frame of a video corresponding to the video playing instruction in the video playing window located in the first display area according to the video playing instruction;
determining video frames to be played according to a preset frame rate, wherein, the video frames to be played are all or part of video frames except for the first video frame, in the video corresponding to the video playing instruction, arranging each video frame of the video frames to be played and the first video frame according to a sequential playing order, so as to generate a video frame playing sequence;
sequentially selecting, according to the sequential playing order, each video frame in the video frame playing sequence as a current video frame, so as to perform the following processing:
determining whether a next video frame, the playing order of which is later than the playing order of the current video frame and is adjacent to the current video frame, is present in the video frame playing sequence; if yes, setting the playing time of the next video frame according to the preset frame rate, and playing the next video frame in the video playing window located in the first display area at the playing time of the next video frame.

7. The mobile terminal according to claim 6, characterized in that, the processor of the mobile terminal further performs the steps of:
receiving an adjusting instruction for the video playing window located in the first display area from a user, the adjusting instruction being a zoom-in instruction a zoom-out instruction or a moving instruction;
adjusting the video playing window according to the adjusting instruction.

8. The mobile terminal according to claim 6, characterized in that, the video playing window is a widget window.

9. The mobile terminal according to claim 8, characterized in that, before obtaining the video playing instruction for playing a video in the video playing window located in the first display area of the mobile terminal, the processor of the mobile terminal further performs the steps of: displaying an identifier of at least one video file in the widget window located in the first display area of the mobile terminal;
the step of obtaining a video playing instruction for playing a video in a video playing window located in a first display area of the mobile terminal comprises:
receiving a selection instruction for an identifier of a video file displayed in the widget
